(19) United States
(12) Patent Application Publication
(10) Pub. No.: US 2012/0011451 A1
(43) Pub. Date: Jan. 12, 2012

(54) SELECTIVE SCREEN SHARING

(75) Inventors: Ravi P. Bansal, Tampa, FL (US); Rick A. Hamilton, II, Richmond, VA (US); Andrew R. Jones, Austin, TX (US); Brian M. O'Connell, Research Triangle Park, NC (US); Keith R. Walker, Austin, TX (US)

(73) Assignee: INTERNATIONAL BUSINESS MACHINES CORPORATION, Armonk, NY (US)

(21) Appl. No.: 12/832,642

(22) Filed: Jul. 8, 2010

(51) Int. Cl. G06F 3/01

(52) U.S. Cl. 715/753

(57) ABSTRACT

A privilege discriminator selects a first user to be in a first group of participants to participate in a screen sharing session. The privilege discriminator selects at least one second user to be in a second group of participants to participate in a screen sharing session. The privilege discriminator selects a first screen region for sharing to at least the first group of participants and selects a second screen region for sharing only to the second group of participants. The privilege discriminator shares the first screen region with at least the first group of participants, wherein the sharing is selecting a device authenticated as being used by one of the first group of participants. The presentation privilege discriminator sharing the second screen region with only the second group, based on selecting the second screen region and selecting the second group, excludes the first group from receiving the second screen region.

### BACKGROUND OF THE INVENTION

1. Field of the Invention

The present invention relates generally to a computer implemented method, data processing system, and computer program product for screen sharing of graphical data from a presenter computer to other computers. More specifically, the present invention relates to selecting subsets of participants or attendees for exclusive viewing of selected graphical data.

2. Description of the Related Art

Presentation of computer outputs to additional computers on a network is called screen sharing service and has been available for ten or more years. The data processing systems that generate the screen sharing presentations or participate in them rely on software generally called screen sharing applications. A screen sharing service example is the IBM® Lotus® Sametime® plugin called Instant Share. IBM, Lotus and Sametime are trademarks of International Business Machines Corporation in the United States, other countries, or both. For example, the presenter can present an entire screen to a distant user for real-time or near real-time viewing.

Currently, no screen sharing application permits a subset of participants to be given privileges to see presenter-selected parts of the screen not available to another subset of participants. In addition, the presenter is not provided feedback concerning how many participants have received an up-to-date view of the presenter's current screen.

### SUMMARY OF THE INVENTION

The present invention provides a computer implemented method, data processing system, and computer program product for discriminating shared media on a network. A privilege discriminator selects at least one first user to be in a first group of participants to participate in a screen sharing session. The privilege discriminator selects at least one second user to be in a second group of participants to participate in a screen sharing session. The privilege discriminator selects a first screen region for sharing to at least the first group of participants. A second screen region is selected for sharing only to the second group of participants. The privilege discriminator shares the first screen region with at least the first group of participants, wherein the sharing can include selecting a device authenticated as being used by one of the first group of participants. The privilege discriminator sharing the second screen region with only the second group, based on selecting the second screen region and selecting the second group, excludes the first group from receiving the second screen region.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2A is a diagram of a participant's screen where the participant is selected into the general group, but is not in a privileged group in accordance with an illustrative embodiment of the invention;

FIG. 2B is a diagram of a participant's screen where the participant is selected into the privileged group in accordance with an illustrative embodiment of the invention;

FIG. 3A is a block diagram of a privilege discriminator executing on a client in accordance with an illustrative embodiment of the invention;

FIG. 3B is a block diagram of a privilege discriminator executing on a server in accordance with an illustrative embodiment of the invention;

FIG. 4 is a flowchart of a privilege discriminator receiving user input to discriminate among participants in accordance with an illustrative embodiment of the invention; and

FIG. 5 is a Venn diagram of the general group of participants and the privileged group of participants in accordance with an illustrative embodiment of the invention.

### DETAILED DESCRIPTION OF THE PREFERRED EMBODIMENT

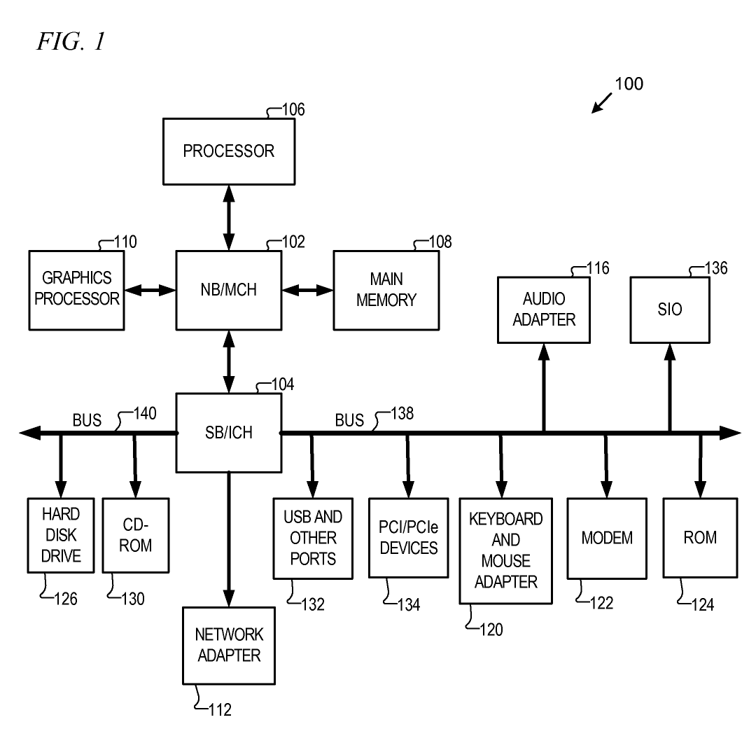

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java programming system, may run in conjunction with the operating system and provides calls to the operating system from Java programs or applications executing on data processing system 100. Java is a trademark of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processor 106. The processes of the present invention can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The illustrative embodiments permit a screen sharing application to select with a presenters direct or indirect input, two groups of participants. The screen sharing application can select a general group of participants and a privileged group of participants. In addition, the screen sharing application may select parts of a presenter's screen to mask out or otherwise skip rendering to the general group. In contrast, the screen sharing application may render such selected part or parts to the computers of participants among the privileged group. In other words, where the participant has authenticated his computer for use as a privileged group member, the participant's computer, or an intermediary computer, can exclusively grant viewing privileges to a privileged part of the presenter's screen to such an authenticated computer, and additional peer computers that are similarly authenticated by people within the privileged group. As a result, side, or back-channel communications may occur between the presenter and the privileged user group participants.

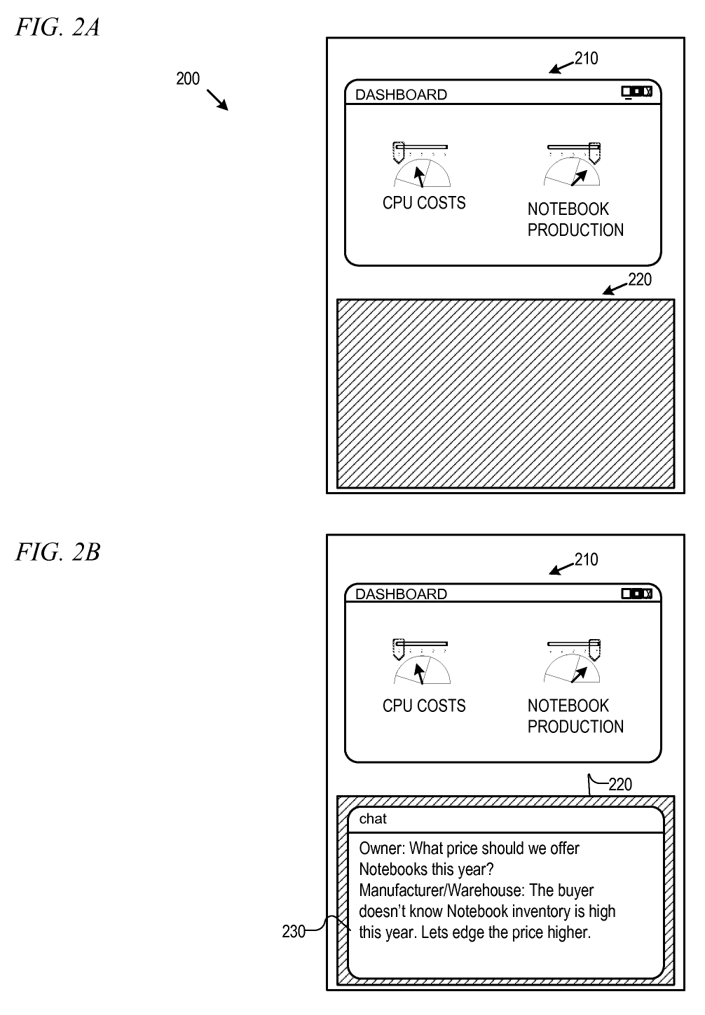

FIG. 2A is a diagram of a participant's screen where the participant is selected into the general group, but is not in a privileged group in accordance with an illustrative embodiment of the invention. A participant is a user that is selected by a presenter to receive graphical data from a screen sharing session controlled from the presenter's computer. A user is represented as an account logged in to a screen sharing session controlled from the presenter's computer. A user is associated to a computer in response to the computer presenting login credentials that match those expected for the person assigned to the account. Accordingly, a user is an abstraction for a person, where signals that originate from a computer that has received the login, are considered to be originating from the user. Similarly, signals sent to the logged in computer are considered sent to the user.

For example, the participant may login or otherwise authenticate the participant's computer to receive shared session data. However, since the participant may not be matched to a privileged group, a portion of the participant's screen may be masked or otherwise excluded from being rendered. Accordingly, a display 200 contains two areas. The first area is general viewing area 210. The second area is masked area 220. A mask or masked area is a region of the participant's screen that corresponds to the privileged screen region of the presenter. The masked area can be a solid color, or patterned area that provides no information concerning the privileged screen region except that the privileged screen region is concealed or otherwise not rendered to the participant in the same manner as rendered on the presenter's screen.

FIG. 2B is a diagram of a participant's screen where the participant is selected into the privileged group in accordance with an illustrative embodiment of the invention. The privileged participant, like all participants in the general group, may participate and view visual elements rendered to his screen, so long as the privileged viewer authenticates his computer as needed. However, additional graphical displays are available to the privileged participant. In addition to general viewing area 210, privileged participants have additional detail presented as privileged area 230. The privileged area 230 may be nested within a masked area, such as masked area 220.

Alternative embodiments may allow the presenter to select a window as the privileged visual element to be shown only to the privileged participant. A screen region for sharing is a region, selected by a presenter, which is designated for sharing or rendering on additional computers, subject to some exceptions. One exception can be that where a second screen region for sharing is associated with an exclusive group, then to the extent that a participant is not in the exclusive group, the second screen region for sharing is excluded by a masked area from the general non-privileged participant's displays. In contrast, the masked area may not be displayed to the privileged participant. In summary, the masked area, as presented to non-privileged participants, blots out details that are present in the presenter's screen, in a position and proportional size that is similar to that of the corresponding presenter's window or screen region.

The privileged screen region can be specified by absolute coordinates of the presenter's screen. In this arrangement, a privilege discriminator application can store the specific pixel boundaries that will be the privileged screen region for the duration of the screen sharing session. Alternatively, the privileged screen region may be a dynamic window. For example, the dynamic window may be an application window. The window is described as ‘dynamic’ in the sense that the presenter may be able to drag and drop the window from one part of the presenter's screen to another. Thus, the operation of the privilege discriminator may coordinate with other applications to alternately transmit screen information of the privileged screen region to the privileged group, and mask the corresponding screen regions to the participants that are in the general group, but not in the privileged group.

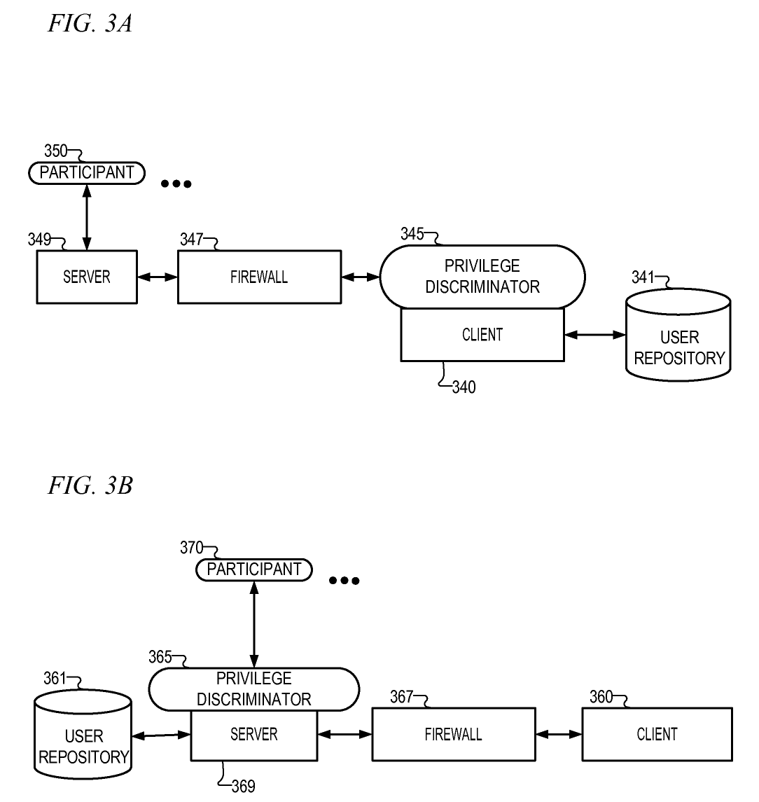

FIG. 3A is a block diagram of a privilege discriminator executing on a client in accordance with an illustrative embodiment of the invention. The client may be a data processing system, for example, data processing system 100 of FIG. 1. Client 340 may rely on user repository 341 to identify participants. The user repository may include tags that attribute features to one or more users. Such features can include a user's role in a company, or a license granted by a government.

Additional attributes can be linked to each user, for example, a frequency with which the user exchanges email with the presenter. Privilege discriminator 345 is a software application that may be executed on a processing unit of a data processing system.

Firewall 347 may mediate data with further networks. Server 349 may provide support for a screen sharing session, for example, authenticating logins from participant computers, and providing routing facilities. Participant computers may be one or more computers, such as, for example participant 350.

FIG. 3B is a block diagram of a privilege discriminator executing on a server in accordance with an illustrative embodiment of the invention. In this configuration, the privilege discriminator 365 is hosted on server 369. Client 360 may transmit both general screen areas and privileged screen areas to the server 369, which identifies which participant is privileged to receive the privileged screen areas. Firewall 367 may mediate data with further networks and between server 369 and client 360. User repository 361 may be hosted on server 369. Participant 370 may be a computer authenticated to access the general screen area, or the general screen area and the privileged screen area. Participant 370 may be one of several participants to a screen sharing session.

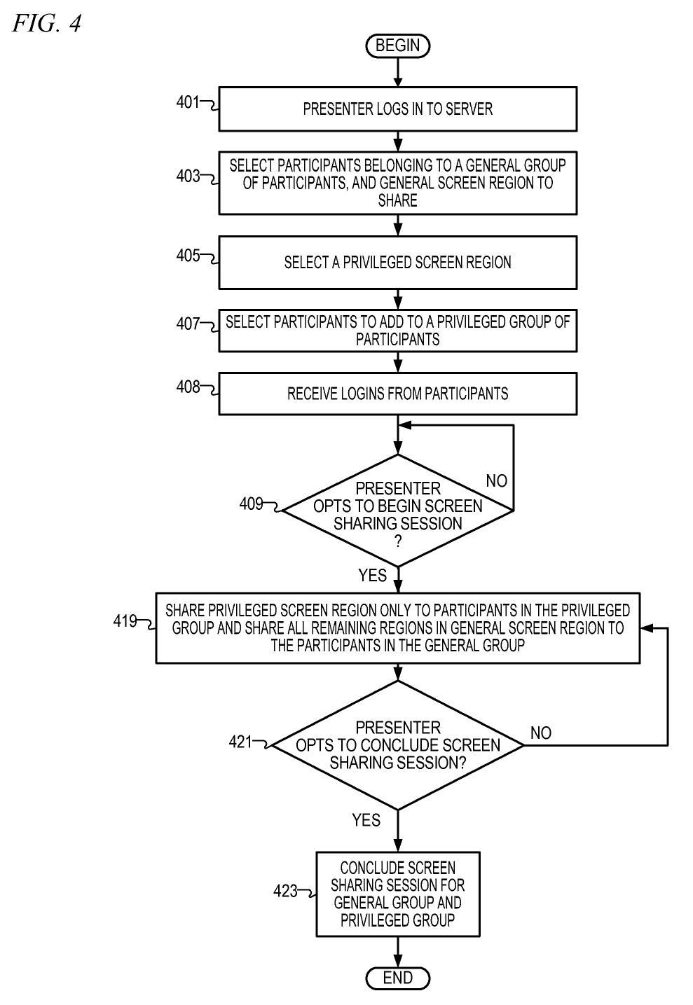

FIG. 4 is a flowchart of a privilege discriminator receiving user input to discriminate among participants during a screen sharing session in accordance with an illustrative embodiment of the invention. Initially, a presenter may log in to a server (step 401). Next, a presenter may start a screen sharing session. Accordingly, the privilege discriminator may select or identify participants belonging to a general group of participants and select a general screen region to share (step 403). A screen sharing session is a session between a presenter's computer and at least one additional computer where a screen is rendered to the presenter's display and the screen is rendered in substantially the same form, to a participant's display. By ‘substantially the same form’, it is understood that the participant's display may be smaller, or have varying resolution than the presenter's display. Accordingly, portions of visual elements visible on the presenter's display may be scaled or cropped as needed to permit an approximation of the presenter's user-experience at the participant's display. Similarly, accommodations may be made for limited color availability at the participant's display. General participants lack privileges set by the presenter. As explained below, such general participants may have portions of their corresponding view masked with respect to a more detailed view present at the presenter's display.

The privilege discriminator may select users to be in a general group of participants to participate in the screen sharing session. Such a selection can be in response to a presenter's input that identifies which users are invited to participate to the screen sharing session. The general group of participants are those that may be provided limited views to the presenter's screen. In contrast, a privileged group is a group of participants selected to receive a privileged screen region to their computers.

Next, the privilege discriminator may select one or more parts of the screen to lock-out or mask out with respect to participants selected to the general group, but not selected to the privileged group. The discriminator performs this step by selecting a privileged screen region (step 405). Selecting the privileged screen region may be responsive to a presenter dragging a frame using a mouse across portions that the presenter wants to keep privileged. Alternatively, the presenter can select a window, for example, by name from a list, or by clicking on the window with a mouse input. Next, the privilege discriminator selects one or more participants to be added to the privileged group (step 407). Adding can include adding a first participant to an empty privileged group.

In addition, the privilege discriminator may receive logins from participants (step 408). It is recognized that the logins may arrive before and after the presenter. Accordingly, the privilege discriminator may receive logins at any time up to the point at which the presenter concludes the screen sharing session.

Next, the privilege discriminator may determine whether the user opts to start a screen sharing session (step 409). A positive determination may cause the privilege discriminator to share privileged screen region only to participants in the privileged group and share all remaining regions in general screen region to the participants in the general group (step 419). Otherwise, a negative determination at step 409 may cause the privilege discriminator to repeat step 409.

Next, the privilege discriminator may determine whether the presenter opts to conclude screen sharing session (step 421). A negative determination may cause the privilege discriminator to repeat step 419.

However, a positive determination may cause the privilege discriminator to conclude the screen sharing session for the general group and for the privileged group (step 423). Concluding the screen sharing for the general group and the privileged group may include sending of a signal to all participants that no further data is to be shared during the current screen sharing session.

As can be seen, step 419 may repeatedly update data rendered to a privileged group of participants. In some cases, the privilege discriminator may update the displays of the general and non-privileged group of participants to a lesser extent, particularly where the update is solely to the privileged screen area. Accordingly, the second screen region for screen sharing, or privileged screen region is only shared to the privileged group of participants. In each case, the screen sharing determination is made based on authentications given by participants invited to the screen sharing session. Thus, when screen sharing of the general screen region for the screen sharing session occurs, the screen sharing is with respect to the group within which a participant belongs.

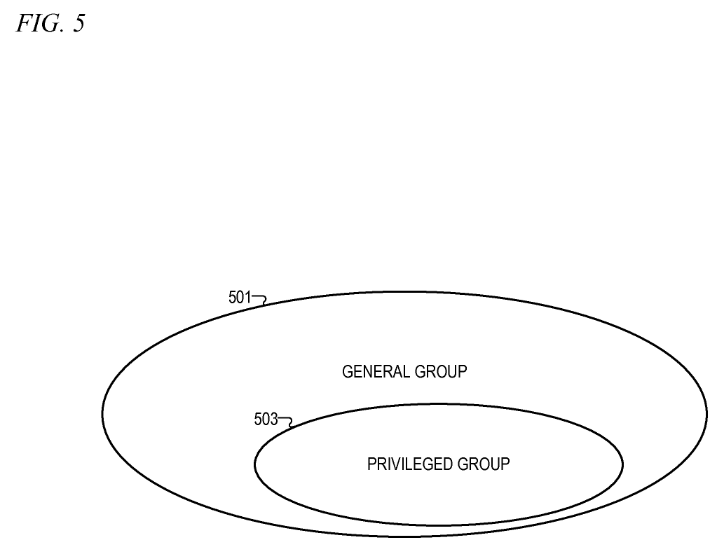

FIG. 5 is a Venn diagram of the general group of participants and the privileged group of participants in accordance with an illustrative embodiment of the invention. General group 501, as explained above, is provided a stream of updates that are subjected to exclusions to the extent that an update is from a presenter-selected privileged screen region. Privileged group 503 is provided the stream of updates for both the general screen area to be shared and the privileged screen area to be shared. As described above, sharing a first screen region is based on the entire video, or multi-media presentation, rendered to at least one monitor of the presenter's computer with a mask covering the second screen region.

Selection of users among the participants to be within the privileged group may include comparing tags of each participant user as looked up in the user repository. For example, as part of step 407, of FIG. 4, the presenter can specify a tag of ‘management’ as a tag to be matched by a participant as a condition to adding the participant to the privileged group. A tag may be a descriptor of the user's title. A title may be a user's profession, title given by an employer, or license category provided by a government. The tags may be tags associated with a user. A manager of the user repository may set such tags. In some cases, the presenter can be the manager of the repository. A tag is a string that describes an attribute of a user and is associated with the user in the user repository. The user repository may provide a look-up functionality in response to setting up screen sharing sessions. A tag may be an organization name to which a user belongs.

Tags may be associated with a file for the purpose of identifying participants whose data may be viewed. Accordingly, one way for the privilege discriminator to select a privileged screen region is to detect when a presenter uses an application to render the contents of a file, and rely on tags of the file to identify which participants are to be selected to the privileged group. Accordingly, steps 405 and 407 may be accomplished by opening a file controlled by the presenter and obtaining a tag corresponding to the file. Thus, based on the tag associated with a participant, the participant is selected to be a member of the privileged group. In other words, where a participant's tag matches a tag of a file, the participant can be added to a privileged group that has viewing privileges for the area of the presenter's screen dedicated to the application that renders the file having a matching tag. A dynamic window is a window that can be moved and/or its shape changed by the presenter. Accordingly, the privileged screen region may cover different parts of the presenter's screen depending on the presenter's movements of the window controlled by the application.

A user repository is any data structure linking users to tags. The user repository may provide authentication functions by also storing a previously shared key or password which the user employs to access data processing resources. The user repository may be arranged according to the Lightweight Directory Access Protocol (LDAP).

It is appreciated that the privilege discriminator may receive inputs periodically from the presenter to add or remove users from the privileged group as needed. Further, the operation of a screen sharing session to a privileged group can be for short conversations that may arise spontaneously. Consequently, exchanges can be made that are concealed from the participants that are not within the ad-hoc-created privileged group.

Thus, the features of the illustrative embodiments may permit fluid opening of files during a presentation. Responsive to opening the files with a suitable application, the data processing system can place limits on which participants can access to privileged screen regions. Consequently, information is allowed to flow to those users who have a ‘need to know’ the information.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for discriminating shared media on a network, the method comprising:
selecting at least one first user to be in a first group of participants to participate in a screen sharing session;
selecting at least one second user to be in a second group of participants to participate in a screen sharing session;
selecting a first screen region for sharing to at least the first group of participants;
selecting a second screen region for sharing only to the second group of participants;
sharing the first screen region with at least the first group of participants, wherein the sharing is selecting a device authenticated as being used by one of the first group of participants; and
sharing the second screen region with only the second group based on selecting the second screen region and selecting the second group, thereby excluding the first group from receiving the second screen region.

2. The computer implemented method of claim 1, wherein selecting the second group of participants is based on tags of users in a user repository.

3. The computer implemented method of claim 1, wherein selecting the second group of participants forms a subset of the first group of participants; and selecting the second group of participants is based on a job title of each first user.

4. The computer implemented method of claim 1, wherein sharing a first screen region is based on the first screen region rendered to at least one display of the participant's computer with a mask covering the second screen region.

5. The computer implemented method of claim 1, wherein selecting second users to be in a second group occurs, at least in part, in response to sharing the second screen region, and wherein sharing the second screen region comprises:
opening a file controlled by a presenter; and
obtaining a tag corresponding to the file.

6. The computer implemented method of claim 1, wherein selecting the second group is performed based on a tag associated with a file being matched to a tag associated with the at least one second user in a user repository.

7. The computer implemented method of claim 6, wherein sharing the second screen region comprises transmitting screen information corresponding to a screen area selected from the group consisting of selected absolute coordinates of a presenter's screen and a dynamic window.

8. A computer system for discriminating shared media on a network, the system comprising:
a processor, a computer readable memory and a computer readable storage medium;
first program instructions to select at least one first user to be in a first group of participants to participate in a screen sharing session;
second program instructions to select at least one second user to be in a second group of participants to participate in a screen sharing session;
third program instructions to select a first screen region for sharing to at least the first group of participants;
fourth program instructions to select a second screen region for sharing only to the second group of participants;
fifth program instructions to share the first screen region with at least the first group of participants, wherein the sharing is selecting a device authenticated as being used by one of the first group of participants;
sixth program instructions to share the second screen region with only the second group based on selecting the second screen region and selecting the second group, thereby excluding the first group from receiving the second screen region; and
wherein the first, second, third, fourth, fifth, and sixth program instructions are stored on the computer readable storage medium for execution by the processor via the computer readable memory.

9. The computer system of claim 8, wherein second program instructions to select the second group of participants is based on tags of users in a user repository.

10. The computer system of claim 8, wherein second program instructions to select at least one second user to be in the second group of participants forms a subset of the first group of participants; and second program instructions to select the second group of participants is based on a job title of each first user.

11. The computer system of claim 8, wherein fifth program instructions to share a first screen region is based on the first screen region rendered to at least one display of the participant's computer with a mask covering the second screen region.

12. The computer system of claim 8, wherein second program instructions to select second users to be in a second group occurs, at least in part, in response to fourth program instructions to share the second screen region, and wherein sixth program instructions to share the second screen region comprises:
seventh program instructions to open a file controlled by a presenter;
eighth program instructions to obtain a tag corresponding to the file; and
wherein seventh and eighth program instructions are stored on the computer readable storage medium for execution by the processor via the computer readable memory.

13. The computer system of claim 8, wherein second program instructions to select the second group are performed based on a tag associated with a file being matched to a tag associated with the at least one second user in a user repository.

14. The computer system of claim 13, wherein sixth program instructions to share the second screen region comprises seventh program instructions to transmit screen information corresponding to a screen area selected from the group consisting of selected absolute coordinates of a presenter's screen and a dynamic window; and wherein eighth program instructions are stored on the computer readable storage medium for execution by the processor via the computer readable memory.

15. A computer program product for discriminating shared media on a network, the program product comprising:
first program instructions to select at least one first user to be in a first group of participants to participate in a screen sharing session;
second program instructions to select at least one second user to be in a second group of participants to participate in a screen sharing session;
third program instructions to select a first screen region for sharing to at least the first group of participants;
fourth program instructions to select a second screen region for sharing only to the second group of participants;
fifth program instructions to share the first screen region with at least the first group of participants, wherein the sharing is selecting a device authenticated as being used by one of the first group of participants;
sixth program instructions to share the second screen region with only the second group based on selecting the second screen region and selecting the second group, thereby excluding the first group from receiving the second screen region; and
wherein the first, second, third, fourth, fifth, and sixth program instructions are stored on the computer readable storage medium.

16. The computer program product of claim 15, wherein second program instructions to select the second group of participants is based on tags of users in a user repository.

17. The computer program product of claim 15, wherein second program instructions to select at least one second user to be in the second group of participants forms a subset of the first group of participants; and second program instructions to select the second group of participants is based on a job title of each first user.

18. The computer program product of claim 15, wherein fifth program instructions to share a first screen region is based on the first screen region rendered to at least one display of the participant's computer with a mask covering the second screen region.

19. The computer program product of claim 15, wherein second program instructions to select second users to be in a second group occurs, at least in part, in response to fourth program instructions to share the second screen region, and wherein sixth program instructions to share the second screen region comprises:
seventh program instructions to open a file controlled by a presenter; and
eighth program instructions to obtain a tag corresponding to the file; and wherein seventh and eighth program instructions are stored on the computer readable storage medium.

20. The computer program product of claim 15, wherein second program instructions to select the second group are performed based on a tag associated with a file being matched to a tag associated with the at least one second user in a user repository.

21. A computer implemented method for discriminating shared media on a network, the method comprising:
selecting at least one first user to be in a first group of participants to participate in a screen sharing session, wherein a participant is a user that is selected by a presenter to receive graphical data from a screen sharing session controlled via a computer controlled by the presenter;
selecting at least one second user to be in a second group of participants to participate in a screen sharing session;
selecting a first screen region for sharing to at least the first group of participants;
selecting a second screen region for sharing only to the second group of participants;
sharing the first screen region with at least the first group of participants, wherein the sharing is selecting a device authenticated as being used by one of the first group of participants; and
sharing the second screen region with only the second group based on selecting the second screen region and selecting the second group, thereby excluding the first group from receiving the second screen region, wherein sharing the second screen region comprises transmitting screen information corresponding to a screen area selected from the group consisting of selected absolute coordinates of a presenter's screen and a dynamic window.
